(19) United States
(12) Patent Application Publication
(10) Pub. No.: US 2009/0102670 A1
(43) Pub. Date: Apr. 23, 2009

(54) Atmospheric Safety Monitoring Device

(76) Inventor: Shane Faulkhead, South Australia (AU)

Correspondence Address: THE NATH LAW GROUP, 112 South West Street, Alexandria, VA, 22314, US

(21) Appl. No.: 11/988,806

(22) PCT Filed: Jul. 14, 2006
(86) PCT No.: PCT/AU2006/000987

§ 371 Date: Mar. 20, 2008

(30) Foreign Application Priority Data
Jul. 15, 2005 (AU) 2005903764

(51) Int. Cl. G08B 21/00

(52) U.S. Cl. 340/603

(57) ABSTRACT

An atmospheric safety monitoring device including a remote sensor unit adapted to sense two or more selected atmospheric contaminants and to communicate data from such sensing to a display unit, said display unit being adapted to display the results of said sensing and to determine if said results indicate that a level of an atmospheric contaminant is outside of an acceptable range and in that case to initiate selected alert behaviour.

### TECHNICAL FIELD

The present invention relates to safety equipment for powered vehicles which have living or working spaces which are occupied while the vehicles are in normal use. It has particular relevance to marine safety device and monitoring the level of gaseous contaminants within a boat's atmosphere. It is also relevant to safety in such land based vehicles as motor homes and railway locomotives.

### BACKGROUND ART

Internal combustion engines used to power boats and motor homes are a significant source of atmospheric contamination aboard the vehicle.

When running, the internal combustion engine produces noxious outputs in the form of smoke, carbon dioxide, nitrous oxides, and carbon monoxide. In sufficient concentration all of these are hazardous to human health

When the motor is not running, the internal combustion engine and associated fuel system may produce fuel vapours. These vapours may be directly harmful to human health in sufficient concentrations. However they present a significantly greater danger in that they may reach a sufficient concentration to make the atmosphere explosive in this case only a source of ignition is required in order for there to be a possibly devastating explosion. This emission source is readily provided by the process of starting the engine if this is attempted while the atmosphere is in an explosive state.

The dangerous nature of atmospheric contamination aboard marine vessels is of course well known. Considerable efforts are made to ensure that the exhaust is vented to the external atmosphere and not permitted to contaminate the atmosphere aboard the vessel.

In practice, ensuring that adequate exhaust occurs throughout a vessel at all times is extremely difficult. The atmospheric conditions surrounding and within a boat change constantly, while the boat may be stationary or travelling with a variety of different speeds. The boat may be in a completely calm atmosphere or it may be exposed to winds of almost any velocity, from any direction. These factors mean that it is extremely difficult to precisely and reliably predict the exact nature of airflow in all parts of the vessel. Accordingly it is very difficult to ensure that pockets of noxious gases do not build up in any areas of the boat. Similar constraints apply to land based vehicles such as motor homes, with the additional constraint that their greater speed of movement and smaller size tends to require that their cabin areas be less open to the outside air.

The designs of the exhaust systems for boat engines attempt to mitigate these problems but there are serious limitations to the options available in a boat particularly in relation to the position and height of the exhaust points.

Ventilation systems are employed in most boats in order to mitigate these problems. However they are generally restricted to the engine rooms or compartments of the boat. They may have no sensors or have only air movement or fuel vapour sensors.

Such ventilation devices are generally designed and to deal with the risk of fuel vapour explosion. The general ventilation of the vessel is left to the air movement caused by wind or the vessels movement and to the design of the exhaust system.

It is an object of the present invention to provide a vehicle safety device that overcomes or at least substantially ameliorates the problems associated with the prior art.

It is a further object of the present invention to provide a vehicle safety device capable of monitoring a variety of atmospheric contaminants aboard a marine vessel.

It is a further object of the present invention to provide a vehicle safety device capable of monitoring a variety of atmospheric contaminants aboard a land based vehicle.

Other objects and advantages of the present invention will become apparent from the following description, taken in connection with the accompanying drawings, wherein, by way of illustration and example, an embodiment of the present invention is disclosed.

### DISCLOSURE OF THE INVENTION

In one form of the invention, it may be said to reside in an atmospheric safety monitoring device including a remote sensor unit adapted to sense two or more selected atmospheric contaminants and to communicate data from such sensing to a display unit, said display unit being adapted to display the results of said sensing and to determine if said results indicate that a level of an atmospheric contaminant is outside of an acceptable range and in that case to initiate selected alert behaviour.

In preference, the atmospheric contaminants are selected from smoke, nitrous oxide, carbon monoxide and fuel vapour.

In preference, further detectable atmospheric contaminants include Formaldehyde, Phosphine, Methyl Bromide, Ethylene Oxide, Hydrogen Cyanide, Sulfuryl Fluoride and Ethylene Dibromide.

In preference, the sensors are of a coil filament and/or chemical reaction type

In preference, the remote sensor unit is further adapted to sense selected other attributes of the atmosphere and to communicate results of this sensing to the display unit, the display unit being further adapted to use said other attribute results when determining it the level of an atmospheric contaminant is outside of an acceptable range.

In preference, the other attributes are one or more of air temperature, humidity and air density.

In preference, the sensing results are displayed as a concentration of a given contaminant as sensed by a given remote sensor.

In preference, the selected alert behaviour is an audible alarm.

In preference, the alert behaviour includes the displaying of the steps of a checklist of responses appropriate the detection of the particular contaminant sensed in the particular area of the vessel where the remote sensor is located.

In preference, the display unit includes means to step through multiple steps of the selected checklist.

In preference, the contents of the checklist are able to be updated from an external data source.

In preference, the display unit is adapted to initiate control activation actions as part of the alert behaviour.

In preference, the remote sensors communicate the data to the display unit as analogue voltage levels.

In preference, the data are communicated to the display unit over a wiring harness.

In preference, the remote sensors communicate the data to the display unit as a digital data stream.

In preference, the data is communicated to the display unit over a wireless protocol.

### BRIEF DESCRIPTION OF THE DRAWINGS

For a better understanding of this invention it will now be described with respect to a preferred embodiment which will be described with the assistance of drawings wherein:

FIG. 1 shows a display unit according to a preferred embodiment of the present invention deployed in a boat,

FIG. 2 shows a remote sensor unit according to a preferred embodiment of the present invention,

FIG. 3 shows a block diagram of the functional components of a sensor unit of a preferred embodiment; and

FIG. 4 shows a block diagram of the functional components of a preferred embodiment of the display unit; and

FIG. 5 shows a flow diagram of the software installed in the display unit of FIG. 1.

### BEST MODE FOR CARRYING OUT THE INVENTION

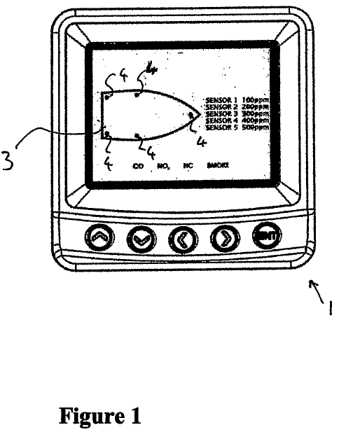

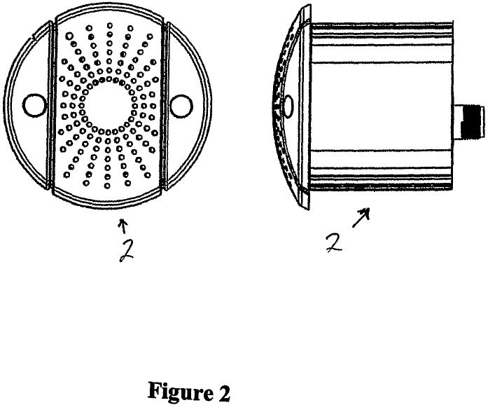

Referring to FIG. 1 and FIG. 2 there is shown an embodiment of the invention deployed in a marine vessel, the vehicle safety device including a display unit 1 and at least one remote sensor unit 2.

The display unit is mounted at a convenient place in the boat where it may be monitored by the crew. Sensor units are distributed about the boat in such areas as require monitoring for airborne contaminants. Sensors would be located in the engine room but also in the crew and passenger areas. Sensors may also be located on deck in areas where build up of an atmospheric contaminant is possible.

The display unit display may be customized in a large number of ways. In this embodiment a sketch outline through of the boat is shown with sensor positions marked. The status of these sensors is indicated by colour on a display

The sensors communicate with the display unit either by simple electrical signals on a wiring harness or by any wired or wireless communications protocol.

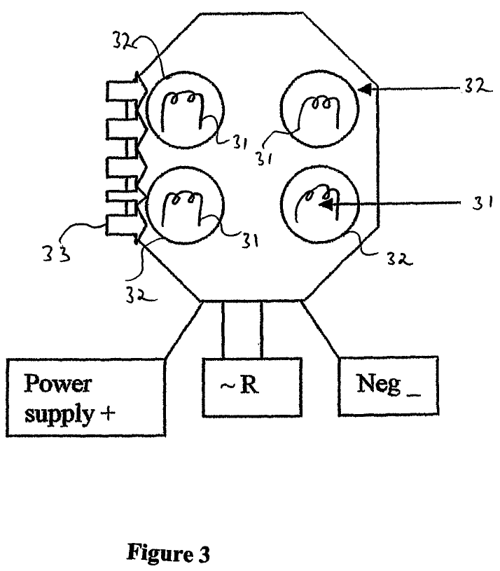

A diagram of a typical sensor of the boat safety device is shown in FIG. 3 The sensors employed are of a known coil filament type.

Coil filaments sensors work by interposing coil filament into the airflow in which contaminants levels are to be measured. The coils are adapted such that there conductivity is related to the level in the airflow of a specific contaminant which is to be monitored.

In the device of the invention this conductivity may be monitored directly by circuitry within the display unit or it may be analysed within the sensor unit and a result indicating the concentration of a particular contaminant within the airflow communicated to the display unit circuitry.

Sensors of the prior art have always been adapted to sense only one type of contaminant. In this embodiment the sensor substrate 30 includes four coil filament sensors 31.

Each of these sensors is adapted to detect the concentration of a different contaminant in the atmosphere. In this case the contaminants sensed are nitrous oxides, carbon monoxide, fuel vapour and smoke.

The coil filament sensors 31 are housed in cylinders 32 through which an airflow 33 is directed. It is the contaminant level of this airflow which is monitored and the results communicated to the display unit processor.

Other characteristics of the airflow can also be sensed. In a further embodiment, the sensor also detects air temperature and relative humidity.

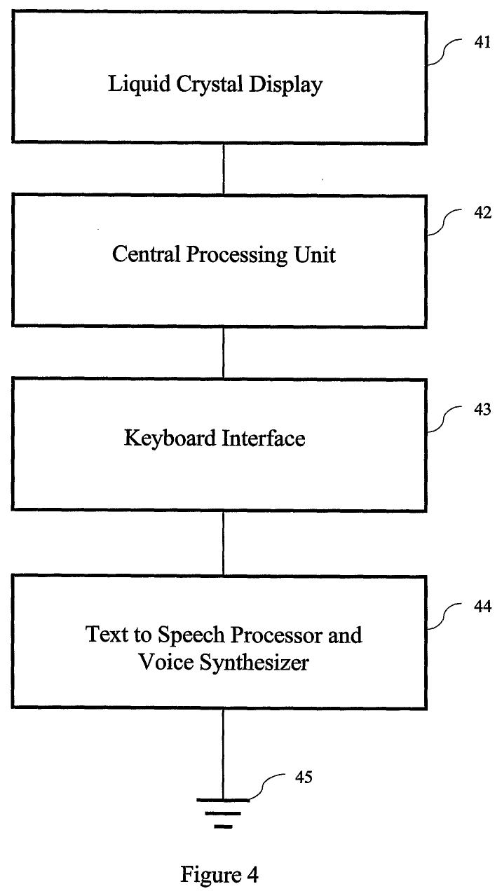

FIG. 4 shows a block diagram of the main display unit of the boat safety device.

This unit includes a liquid crystal display 41 which displays the status of the remote sensors. It also shows such communication displays as are required for setting up and calibrating the device.

There is a central processing unit 42 which includes processing and memory capabilities. Information is communicated to the device by a keyboard interface 43.

The display unit is connected to the remote sensors by a series of analogue wires or a wired or wireless protocol communication system 45. In use the central processing unit monitors the resistance values returned by each individual filament sensor 31 within the network of remote sensors 30 and converts these values to readings in parts per million of the monitored contaminants. In an embodiment where the sensors communicate via a communications protocol this step may be performed by sub-processors within each sensor unit and the results transmitted back to the central processing unit of the display unit.

These readings are compared to the set points for each contaminant. If the contaminants exceed the specified maxima then alert behaviour is initiated. The set points may be absolute values of the concentration of a given contaminant or they may vary with the value of other results from the sensor. For example, different levels of a contaminant may be acceptable in cold conditions as opposed to warm conditions.

The detector in the alert condition is indicated on a display in the liquid crystal display. An audible warning is sounded.

The required response to each alert condition may be set out in checklists relevant to the particular boat and configuration. These checklists are compiled by the equipment manufactures or by the vessel operators. These checklists are used to guide operators in responding to alert conditions.

Traditionally Such checklists are kept in paper form on the vessel and must be accessed and laboriously followed in an alert situation. This can be very difficult for a single operator or in difficult environmental conditions.

Such checklists may be held in the memory of the display unit. They are loaded as part of the software loading process.

When an alert condition is sensed the appropriate checklist is accessed and a text to speech processor with a voice synthesizer 44 is brought into use to speak the checklist for the user.

The user may move forward or back through the checklist as appropriate using the keyword interface. The written details of the checklist steps may also be displayed on the liquid crystal display.

The use of the checklist ensures that no step is missed whilst not requiring that the crew leafs through the unit's paper checklists in circumstances where the nature of an emergency makes access to paper checklists difficult.

The alarm levels for each of these sensors may be factory set when the said device is manufactured or they may be individually set by use of the keyboard interface.

The alarm levels may be absolute part per million levels of detected contaminant, but in a further embodiment the alarm levels are determined by a defined relationship between any two or more sensor results.

In a further embodiment, the remote sensor detects air temperature and humidity. These results are also taken into account, along with contaminant sensor readings, in determining whether an alarm condition exists.

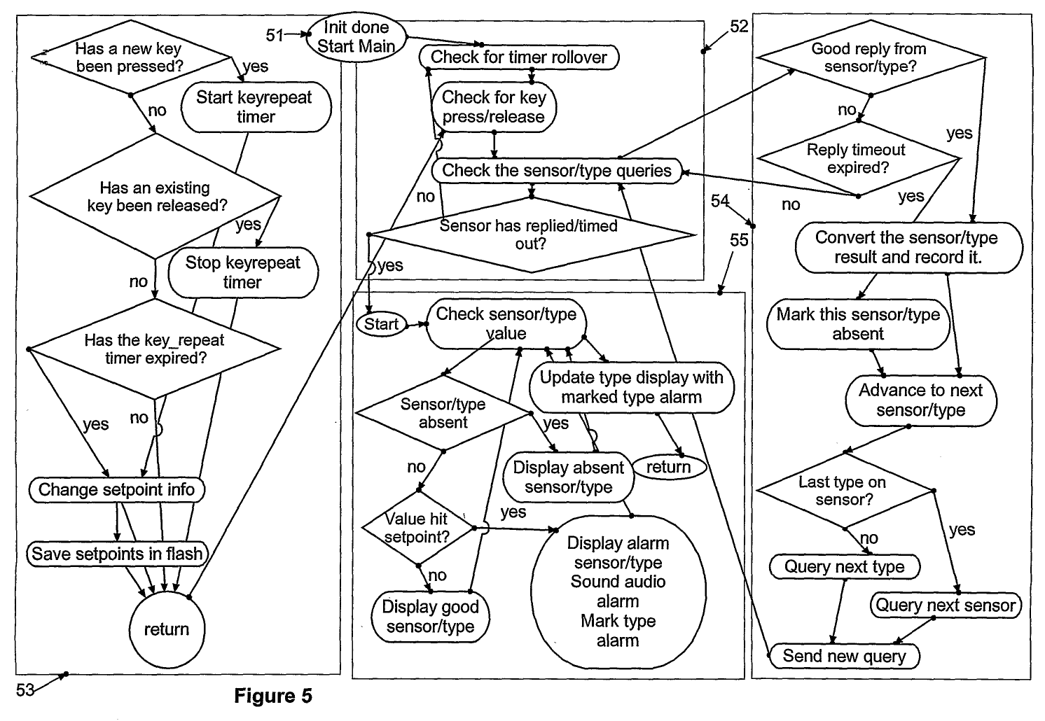

FIG. 5 shows a high level flow diagram of the software within the central processing unit of the display unit.

Program execution begins with an initialisation step 51. The device then goes into a main polling routine 52 which continues whilst the unit remains in operation. This main polling routine checks to see if a key has been pressed. If so, it calls the key handling routine 53 to deal with input from the unit keyboard interface.

The sensor handling routine 54 is then called to query and analyse the data from the remote sensors.

If any of this has changed the update display routine 55 is called which displays the changed sensor data, checks if any alert behaviour is required and initiates the alert behaviour if required.

The main polling routine is then repeated for so long as the unit remains operational.

The details of checklists and alert responses are held within the central processing unit in non volatile memory. These details may be updated by any normal means, including by direct replacement of the physical memory and by the downloading of new data from a portable programming unit.

In an embodiment the display unit is adapted to initiate control activation actions in response to alert conditions. Such control response actions may include operating fans, operating motors, operating vents and any other control action a crew member might otherwise take in response to an alarm condition.

The display unit controls machinery and devices aboard the vessel either by means of a network protocol or by direct electrical signals. The network protocol may be transmitted over any appropriate wired or wireless network.

The examples illustrated show the invention installed in a marine vessel. The invention may equally be installed in a land based vehicle such as a motor home or a railway locomotive.

Although the invention has been herein shown and described in what is conceived to be the most practical and preferred embodiment, it is recognised that departures can be made within the scope of the invention, which is not to be limited to the details described herein but to embrace any and all equivalent devices in apparatus.

1-16. (canceled)

17. An atmospheric safety monitoring device including a remote sensor unit adapted to sense two or more selected atmospheric contaminants and to communicate data from such sensing to a display unit, said display unit being adapted to display the results of said sensing and to determine if said results indicate that a level of an atmospheric contaminant is outside of an acceptable range and in that case to initiate selected alert behaviour appropriate to the contaminant detected and/or the location of the remote sensor.

18. The atmospheric safety monitoring device of claim 17 wherein the atmospheric contaminants are selected from smoke, nitrous oxide, carbon monoxide and fuel vapour.

19. The atmospheric safety monitoring device of claim 17 wherein the sensors are of a coil filament and/or chemical reaction type.

20. The atmospheric safety monitoring device of claim 18, wherein the remote sensor unit is further adapted to sense selected other attributes of the atmosphere and to communicate results of this sensing to the display unit, the display unit being further adapted to use said other attribute results when determining if the level of an atmospheric contaminant is outside of an acceptable range.

21. The atmospheric safety monitoring device of claim 20 wherein the other attributes are one or more of air temperature, humidity and air density.

22. The atmospheric safety monitoring device of claim 17, wherein the sensing results are displayed as a concentration of a given contaminant as sensed by a given remote sensor.

23. The atmospheric safety monitoring device of claim 17, wherein the selected alert behaviour includes sounding an audible alarm.

24. The atmospheric safety monitoring device of claim 17, wherein the alert behaviour includes the displaying of the steps of a checklist of responses appropriate the detection of the particular contaminant sensed in the particular area of the vessel where the remote sensor is located.

25. The atmospheric safety monitoring device of claim 24, wherein the display unit includes means to step through multiple stops of the selected checklist.

26. The atmospheric safety monitoring device of claim 24, wherein the contents of the checklist are able to be updated from an external data source.

27. The atmospheric safety monitoring device of claim 17, wherein the display unit is adapted to initiate control activation actions as part of the alert behaviour.

28. The atmospheric safety monitoring devise of claim 17 wherein the remote sensors communicate the data to the display unit as analogue voltage levels.

29. The atmospheric safety monitoring device of claim 28 wherein the data are communicated to the display unit over a wiring harness.

30. The atmospheric safety monitoring device of claim 17 wherein the remote sensors communicate the data to the display unit as a digital data stream.

31. The atmospheric safety monitoring device of claim 30 wherein the data is communicated to the display unit over a wireless protocol.

32. An atmospheric safety monitoring device substantially as described in the specification with reference to and as illustrated by any one or more of the accompanying drawings.

33. The atmospheric safety monitoring device of claim 18, wherein the sensing results are displayed as a concentration of a given contaminant as sensed by a given remote sensor.

34. The atmospheric safety monitoring device of claim 20, wherein the selected alert behaviour includes sounding an audible alarm.

35. The atmospheric safety monitoring device of claim 21, wherein the alert behaviour includes the displaying of the steps of a checklist of responses appropriate the detection of the particular contaminant sensed in the particular area of the vessel where the remote sensor is located.

36. The atmospheric safety monitoring device of claim 24, wherein the display unit is adapted to initiate control activation actions as part of the alert behaviour.
